(19) United States
(12) Patent Application Publication
(10) Pub. No.: US 2012/0202552 A1
(43) Pub. Date: Aug. 9, 2012

(54) WIRELESS UNIT AND MOBILE COMMUNICATION TERMINAL WITH THE WIRELESS UNIT

(75) Inventors: TAKASHI MINEMURA, Ome-shi (JP); KENGO KUROSE, Hamura-shi (JP); YUKI HAYASHI, Ome-shi (JP)

(73) Assignee: Kabushiki Kaisha Toshiba, Tokyo (JP)

(21) Appl. No.: 13/312,792

(22) Filed: Dec. 6, 2011

(30) Foreign Application Priority Data
Feb. 8, 2011 (JP) 2011-025031

(51) Int. Cl. H04W 52/04; H04B 7/24

(52) U.S. Cl. 455/522

(57) ABSTRACT

According to one embodiment, a wireless unit includes a first wireless module, a second wireless module, and a notification module. The first wireless module is receives identification signal transmitted from the base station, and to detect whether the base station is available, the identification signal includes information associated with the base station. The second wireless module is operates with less power consumption than the first wireless module and to detect whether the identification signal arrives in predetermined period. The notification module is notify to an external module when the identification signal arrives to the second wireless module in predetermined period.

### CROSS-REFERENCE TO RELATED APPLICATIONS

This application is based upon and claims the benefit of priority from prior Japanese Patent Application No. 2011-025031, filed Feb. 8, 2011, the entire contents of which are incorporated herein by reference.

### FIELD

Embodiments described herein relate generally to a wireless unit that makes wireless communication with a base station, and a mobile communication terminal with the wireless unit.

### BACKGROUND

So-called area search processing of searching for a neighboring base station is performed in order to detect a service area formed by the base station in a wireless unit mounted on a mobile communication terminal. The area search processing needs to be performed perpetually or intermittently in a standby state and thus how much power consumption can be reduced is an important issue.

Therefore, a technique is proposed in which a wireless device is provided with a low-power-consumption ultra-power-saving receiver, only the low-power-consumption ultra-power-saving receiver is operated in a standby state, and when the low-power-consumption ultra-power-saving receiver receives a wireless signal transmitted from other wireless device, a main transmitter and a main receiver in the wireless device are operated to start communication.

Since the low-power-consumption ultra-power-saving receiver only has the function of simply receiving a wireless signal transmitted from a base station, it is impossible to identify which base station has transmitted the wireless signal. Thus, the main transmitter and receiver need to be operated each time a wireless signal is received, to receive identification information transmitted from the base station and to identify the source base station. Therefore, power consumption in the entire wireless device is still high and further reduction in power consumption is required.

The present invention has been made in light of the above situations, and it is an object of the present invention to provide a wireless unit capable of further reducing power consumption while identifying an available base station, and a mobile communication terminal with the wireless unit.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic structural diagram of a mobile communication network system utilized by a mobile communication terminal according to a first embodiment;

FIG. 2 is a block diagram showing a structure of the mobile communication terminal according to the first embodiment;

FIG. 3 is a flowchart showing an area search processing procedure and processing contents by a low-power-consumption wireless module and a wireless module in the device shown in FIG. 2;

FIG. 4 is a diagram for explaining processing contents of a beacon search processing by the low-power-consumption wireless module shown in FIG. 2;

FIG. 5 is a diagram for explaining information on a search result obtained by the beacon search processing shown in FIG. 4, and an operation of detecting a new beacon and a lost beacon;

FIG. 6 is a diagram showing an SSID search result list by the wireless module shown in FIG. 2;

FIG. 7 is a diagram showing a first example of a list in which the beacon search result is associated with the SSID search result;

FIG. 8 is a diagram showing a second example of the list in which the beacon search result is associated with the SSID search result;

FIG. 9 is a diagram showing a third example of the list in which the beacon search result is associated with the SSID search result;

FIG. 10 is a diagram showing a fourth example of the list in which the beacon search result is associated with the SSID search result;

FIG. 11 is a diagram showing a fifth example of the list in which the beacon search result is associated with the SSID search result;

FIG. 12 is a schematic structural diagram of a mobile communication terminal according to a second embodiment;

FIG. 13 is a timing chart showing beacon search periods and an SSID acquiring period by the mobile communication terminal shown in FIG. 12;

FIG. 14 is a schematic structural diagram of a mobile communication terminal according to a third embodiment; and

FIG. 15 is a schematic structural diagram of a mobile communication terminal according to a fourth embodiment.

### DETAILED DESCRIPTION

Various embodiments will be described hereinafter with reference to the accompanying drawings.

In general, according to one embodiment, a wireless unit that makes wireless communication with a base station comprises a first wireless module configured to receive identification information on the base station transmitted from the base station, a second wireless module configured to operate with less power consumption than the first wireless module and to receive a beacon signal transmitted from the base station, and a control module connected with the first and second wireless modules. The second wireless module comprises a determiner configured to detect reception power of the beacon signal and to determine whether the detected reception power of the beacon signal is a predetermined threshold or more, and an output interface configured to, when the beacon signal for which the detected reception power is determined to be the threshold or more is detected, output identification detection information containing information on the detected beacon signal to the control module. The control module comprises a first controller configured to receive identification detection information output from the second wireless module, a second controller configured to, when the received identification detection information contains information on a new beacon signal, operate the first wireless module for a certain period of time, a third controller configured to receive identification information contained in control data received by the first wireless module during the operation period from the first wireless module, and a fourth controller configured to associate the received identification information with information on the beacon signal contained in the received identification detection information and to store information on the association.

### First Embodiment

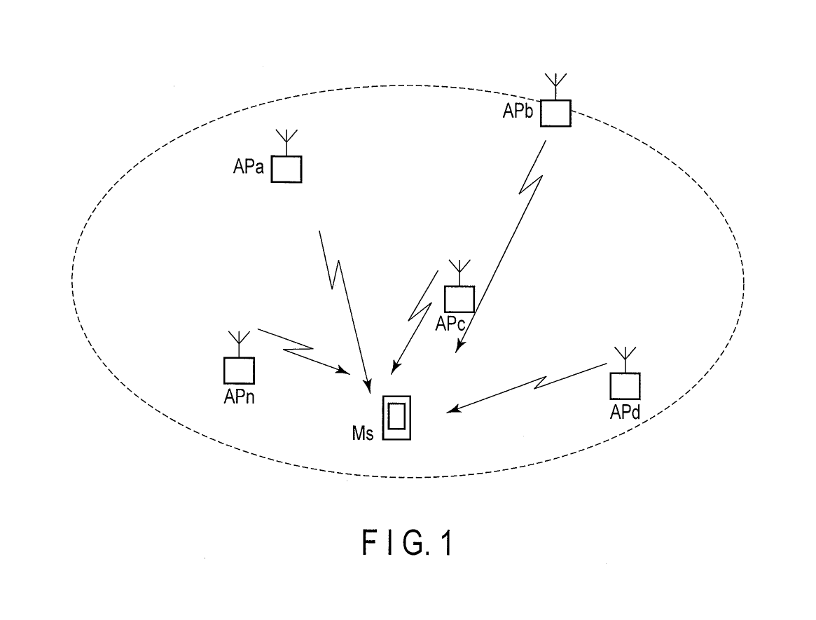

FIG. 1 shows a mobile communication network system utilized by a mobile communication terminal according to a first embodiment, and shows a wireless local area network (LAN) by way of example.

With the wireless LAN, a plurality of base stations (which will be referred to as access points below) AP1 to APn are distributed in service areas and access points AP1 to APn form the service areas, respectively. A mobile communication terminal MS searches for the service areas of access points AP1 to APn, and selects a communicable access point based on the search result to make wireless communication with the access point. The mobile communication network system is not limited to the wireless LAN and may be other system employing a wireless communication system for making a similar area search such as Bluetooth (trademark) or WiMAX (trademark).

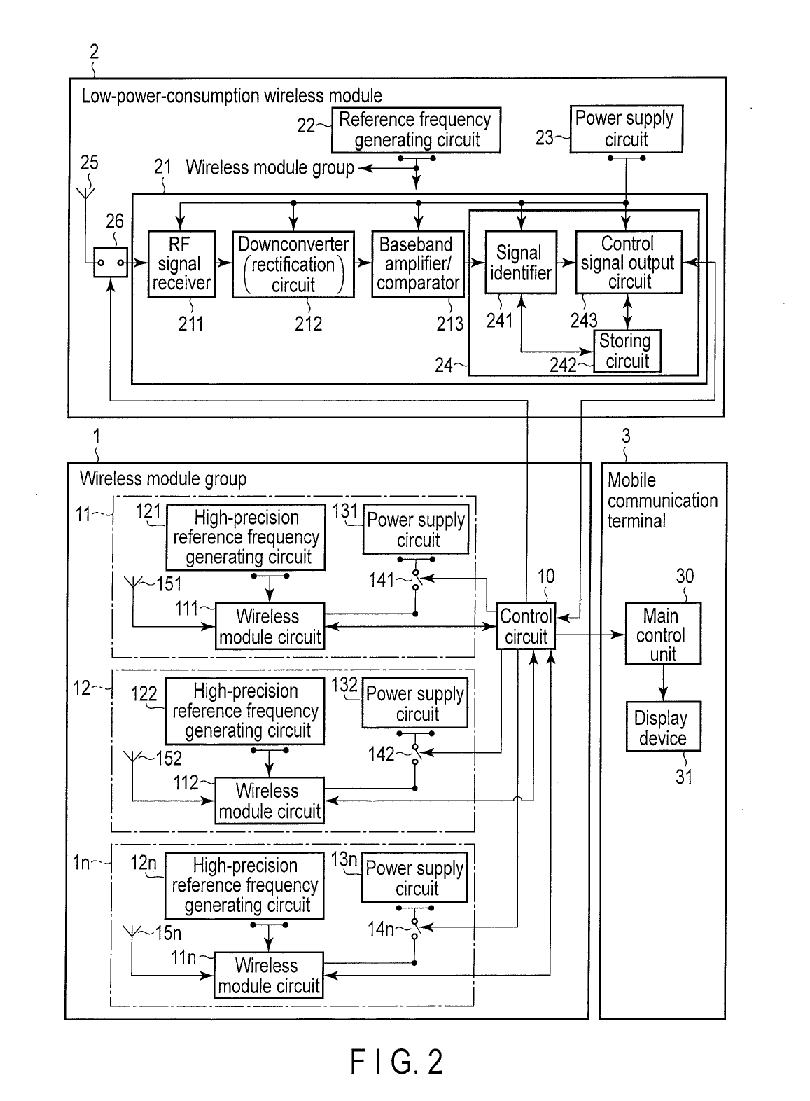

FIG. 2 is a block diagram showing a structure of the mobile communication terminal MS. The mobile communication terminal MS is configured of a wireless module group 1, a low-power-consumption wireless module 2, and a cell phone main body 3.

The mobile communication terminal main body 3 comprises a main control unit 30 that is configured of a cell phone, a smart phone, a personal digital assistant (PDA), a tablet terminal or a notebook computer, for example, and has a function as a host central processing unit (CPU), and a display section 31 connected to the main control unit 30 via a display interface (not shown). The display section 31 has a display device using a liquid crystal display (LCD) or an organic EL display, for example.

The wireless module group 1 comprises a plurality of wireless modules 11 to 1n and a control circuit 10. The wireless modules 11 to 1n are a wireless LAN module, a Bluetooth module or a WiMAX module, for example, and have wireless module circuits 111 to 11n, high-precision reference frequency generating circuits 121 to 12n, power supply circuits 131 to 13n, power supply switches 141 to 14n, and antennas 151 to 15n, respectively.

The power supply circuits 131 to 13n generate power necessary to operate the wireless module circuits 111 to 11n, and supply the generated power to the wireless module circuits 111 to 11n via the power supply switches 141 to 14n. The power supply switches 141 to 14n turn on or off depending on a power on/off control signal output from the control circuit 10.

The wireless LAN module 11 among the wireless modules 11 to 1n is configured as follows. In other words, the wireless LAN module 11 is called WiFi (trademark) module and the wireless module circuit 111 performs an exchange operation while power is being supplied from the power supply circuit 131.

Identification information (SSID) on the access point transmitted by access point AP1 to APn is received via the antenna 151. A connectable base station is selected based on the received SSID and wireless LAN communication is made with the selected base station. The high-precision reference frequency generating circuit 121 generates a synchronization clock necessary for an exchange operation in the wireless module circuit 111 and supplies it to the wireless module circuit 111.

The low-power-consumption wireless module 2 is referred to as an ecochip which is configured such that power consumption is lower than the wireless modules 11 to 1n, and is used to detect a beacon transmitted as an identification signal by access point AP1 to APn.

The low-power-consumption wireless module 2 comprises a low-power-consumption wireless module circuit 21, a reference frequency generating circuit 22, a power supply circuit 23, an antenna 25, and an antenna switch 26. The power supply circuit 23 generates power necessary for the receiving operation of the low-power-consumption wireless module circuit 21 and supplies it to the low-power-consumption wireless module circuit 21. The reference frequency generating circuit 22 generates a reference clock (such as 32.768 kHz) necessary for the receiving operation of the low-power-consumption wireless module circuit 21 and supplies it to the low-power-consumption wireless module circuit 21.

The low-power-consumption wireless module circuit 21 has an analog processing section and a digital processing section 24. The analog processing section has an RF signal receiving section 211, a down converter 212 and a baseband amplifier/comparator 213. The RF signal receiving section 211 low-noise amplifies a wireless signal received by the antenna 25 and then passes it through only a desired band. The down converter 212 frequency-converts the frequency of the wireless signal output from the RF signal receiving section 211 into a baseband frequency and thus outputs an envelope-detected baseband signal. The baseband amplifier/comparator 213 adjusts a signal level of the envelope-detected baseband signal by an automatic gain control amplifier, and compares it with different reference voltages by a plurality of comparators, thereby deciding the signal level.

The digital processing section 24 has a signal identifying section 241, a storage section 242, and a control signal output section 243. The signal identifying section 241 has the following processing functions.

(1) A signal indicating a signal level decision result is fetched from the baseband amplifier/comparator 213, and the signal is partitioned per search window and stored in the storage section 242. A time length of the search window is set at a time length (such as 102.4 ms) depending on a beacon transmission period of access points AP1 to APn.

At this time, the storage section 242 has a plurality of registers. The register has (512, for example) positions corresponding to the time length (such as 102.4 ms) of the search window. The storage section 242 stores the signal partitioned per search window by the signal identifying section 241 in the registers, respectively.

(2) The signals stored in the registers are read, the signals at the same position are accumulated, and the accumulation data is stored in an accumulation memory in the storage section 242. A signal value of the accumulation data is compared with a preset threshold, a beacon having a reception signal level exceeding the threshold is detected and the detection data is stored as a search result list in a search result list memory inside the storage section 242.

When the signal identifying section 241 detects a beacon for which an accumulation value of the reception signal is the threshold or more, the control signal output section 243 transmits information on the decision result to the control circuit 10 in the wireless module group 1 together with the search result list and data on the reception signal level (reception power value).

The control circuit 10 is configured of a microcomputer, for example, and has the following control functions.

(1) Whenever the information on the decision result is transmitted from the low-power-consumption wireless module 2, the search result list and the data on the reception signal level (reception power value), which are transmitted at the same time with the decision result information, are sequentially stored in a memory inside the control circuit.

(2) When the latest search result list is stored in the internal memory, the latest search result list is compared with the past search result list stored in the memory. A decision is made for the latest search result list as to whether information on new beacon detection is contained, a beacon has disappeared or a beacon being detected is changed.

(3) When a beacon is detected by the decision processing, a power supply voltage is supplied from the power supply circuit 131 to the wireless module circuit 111 to set the wireless module circuit 111 at an operation state. During the operation period, the SSID of the access point received in the wireless module circuit 111 is received from the wireless module circuit 111, and after the reception, the power supply to the wireless module circuit 111 is interrupted to recover the wireless module circuit 111 to an operation stop state.

(4) The acquired SSID of the access point is associated with the beacon detection information contained in the search result list previously received from the low-power-consumption wireless module 2, and the information on the association between the SSID and the beacon detection information is stored in the memory inside the control circuit 10.

(5) The presence of an available access point is decided based on the information on the association between the SSID and the beacon detection information stored in the internal memory, and if an available access point is present, notification information indicating the fact is generated and output to the main control unit 30 in the cell phone main body 3.

(6) When transmitting a signal for requesting to transmit the SSID to access points AP1 to APn, for example, the wireless module circuit 111 powers off the antenna switch 26 of the low-power-consumption wireless module 2 during the transmission period so that the wireless signal transmitted by the wireless module circuit 111 is not input to the low-power-consumption wireless module circuit 21 in the low-power-consumption wireless module 2.

Then, the operations of the mobile communication terminal MS configured as described above will be explained.

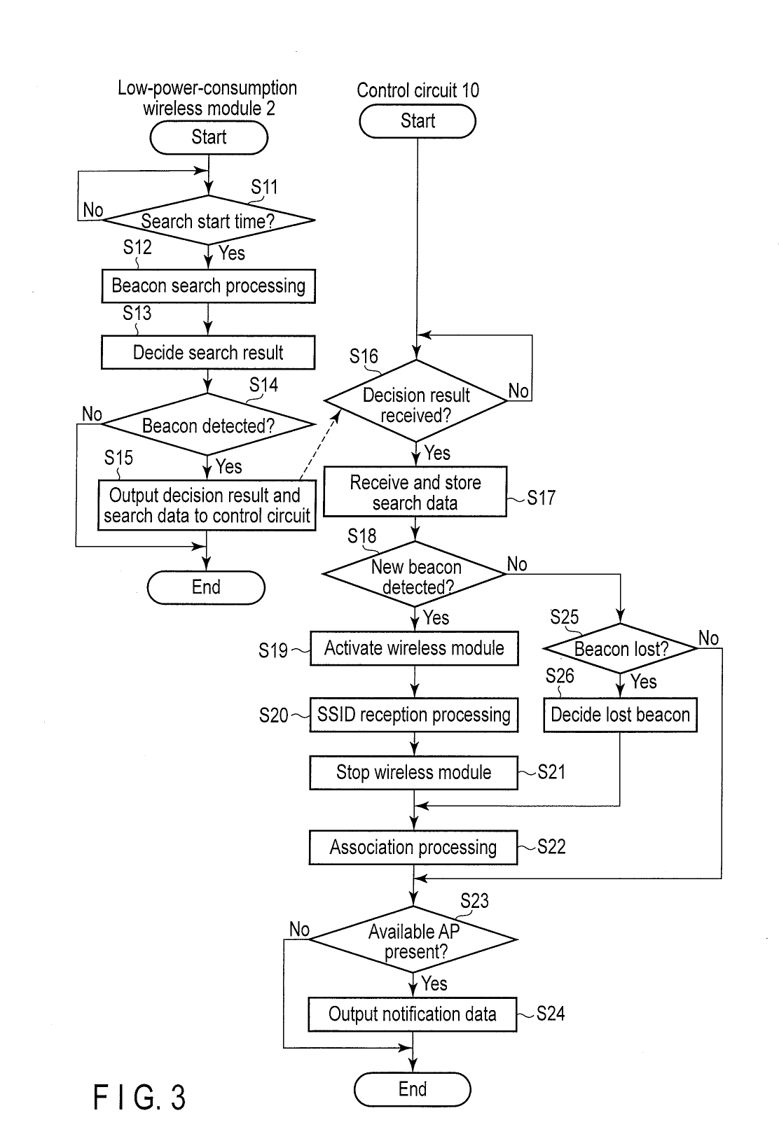

There will be described by way of example a case in which the low-power-consumption wireless module 2 and the wireless LAN wireless module 11 are used to communicate with the wireless LAN access points AP1 to APn. FIG. 3 is a flowchart showing the processing procedures and the processing contents of the low-power-consumption wireless module 2 and the control circuit 10 at this time.

(1) Beacon Search Processing by Low-Power-Consumption Wireless Module 2

The low-power-consumption wireless module circuit 21 in the low-power-consumption wireless module 2 performs a beacon's intermittent receiving operation under control of the control circuit 10, for example. In other words, in step S11, it is monitored whether the beacon search start time has been reached, and when the search start time is reached, the beacon search processing is performed in step S12 as follows.

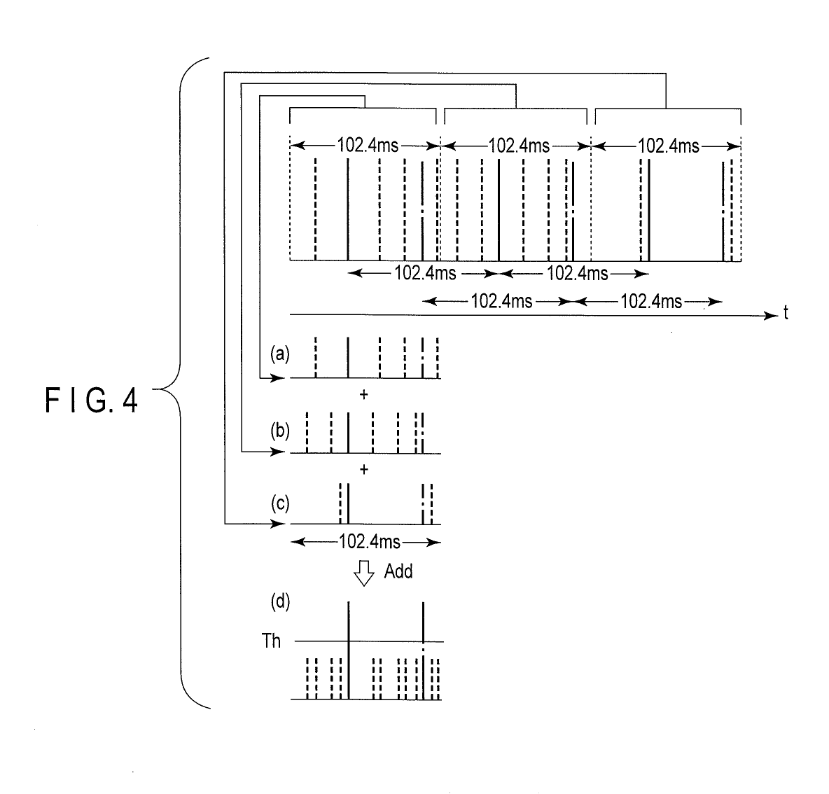

In other words, the signal identifying section 241 in the digital processing section 24 detects a reception timing of a signal which is likely to be a beacon from the received baseband signal output from the baseband amplifier/comparator 213 with the beacon transmission period (102.4 ms) of access points AP1 to APn as a search window. Specific examples of the operation will be shown in FIG. 4. In the figure, a solid line and a chain line indicate a beacon, and a dashed line indicates data.

As shown in FIG. 4, assuming that the search window with the search width of 102.4 ms (beacon transmission period of access point) is an reception profile, a plurality of reception profiles (a) to (c) are sequentially stored in the registers in the storage section 242 and then the signals which have received the reception profiles at the same timing are sequentially added to obtain accumulation data (d) of the reception profiles. The signal processing serves as time filter. Thus, assuming that even when a Carrier Sense Multiple Access/Collision Avoidance (CSMA/CA) system is employed, access points AP1 to APn do not change the transmission timing, only the beacon transmitted at the same period as the search window appears at the same time position, thereby obtaining the accumulation data.

In contrast, a randomly-occurring interference wave is relatively restricted as compared with the beacon. Burst-occurring traffic data with no periodicity has a burst performance so that it is less likely to be present at the same period as the search window and does not take a large accumulation value unlike the beacon.

As shown in FIG. 4, in addition to the method for adding a plurality of reception profiles to emphasize the beacon, there may be employed a method for taking a correlation between consecutive search windows to emphasize the beacon. This is directed for finding AND for the received baseband signals having the same timing of the time-consecutive reception profiles, that is, substantially accumulating the same. In this way, the signals in which high signals are consecutive at the same timing, that is, only the signals which are likely to be a beacon can be obtained.

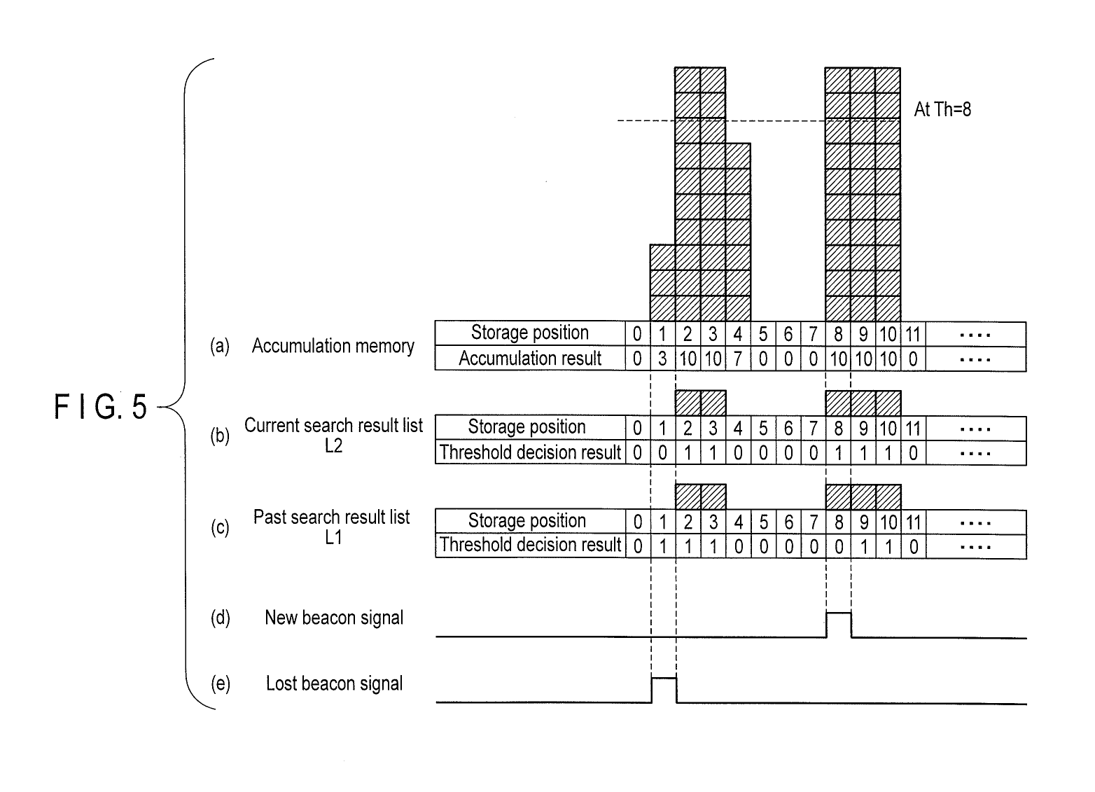

Subsequently, the signal identifying section 241 compares the accumulation data with a preset threshold to detect a beacon from the search windows in step S13. For example, assuming that the accumulation data is of FIG. 5(a), a signal exceeding the threshold Th=8 is detected as a beacon from the accumulation data. Then, the data on the detection result is stored as the current search result list L2 as shown in FIG. 5(b) in the memory inside the storage section 242.

The threshold Th may be variably set depending on the number of samples of the wireless LAN signal (the number of accumulations). The threshold Th may be decided in consideration of an influence by an offset reception timing of the beacon. In other words, the threshold Th is set to be small when the traffic is so high that an offset of the reception timing frequently occurs, and otherwise is set to be relatively large.

Next, the control signal output section 243 decides in step S14 whether the beacon has been detected based on the current search result list L2 stored in the storage section 242. When at least one beacon has been detected, in step S15, the information indicating that the beacon has been detected is transmitted to the control circuit 10 in the wireless module group 1 together with the current search result list L2 and the accumulation data by which the list has been obtained.

(2) Detected Beacon Type Decision Processing

The control circuit 10 monitors the arrival of the decision result in step S16. In this state, when the information on the decision result is transmitted from the low-power-consumption wireless module 2, the search result list L2 and the accumulation data on the reception signal level (reception power value), which are transmitted together with the information on the decision result, are received and stored in the memory inside the control circuit 10 in step S17.

Then, in steps S18 and S25, the control circuit 10 compares the newly-received current search result list L2 with the previously-received and stored past search result list L1 to decide the presence of a new beacon and the presence of a lost beacon for the current search result list L2. For example, when the beacon not present in the past search result list L1 is present in the current search result list L2 as shown in FIGS. 5(b) and 5(c), this is decided as a new beacon as shown in FIG. 5(d). On the other hand, when the beacon present in the past search result list L1 disappears from the current search result list L2 as shown in FIGS. 5(b) and 5(c), this is decided as a lost beacon as shown in FIG. 5(e).

(3) SSID Search Processing

When it is decided that a new beacon is present in the current search result list L2, the control circuit 10 activates the wireless module 11 in step S19. The processing of activating the wireless module 11 is performed by outputting a power-on control signal to power on the power supply switch 141 and supplying operation power from the power supply circuit 131 to the wireless module circuit 111.

When the wireless module circuit 111 enters a receiving operation state, the control data transmitted from access points AP1 to APn is received via the antenna 151 and the SSID is detected from the control data. The detected SSID is fetched in the control circuit 10 and is stored in the SSID search result memory inside the control circuit 10 in step S20.

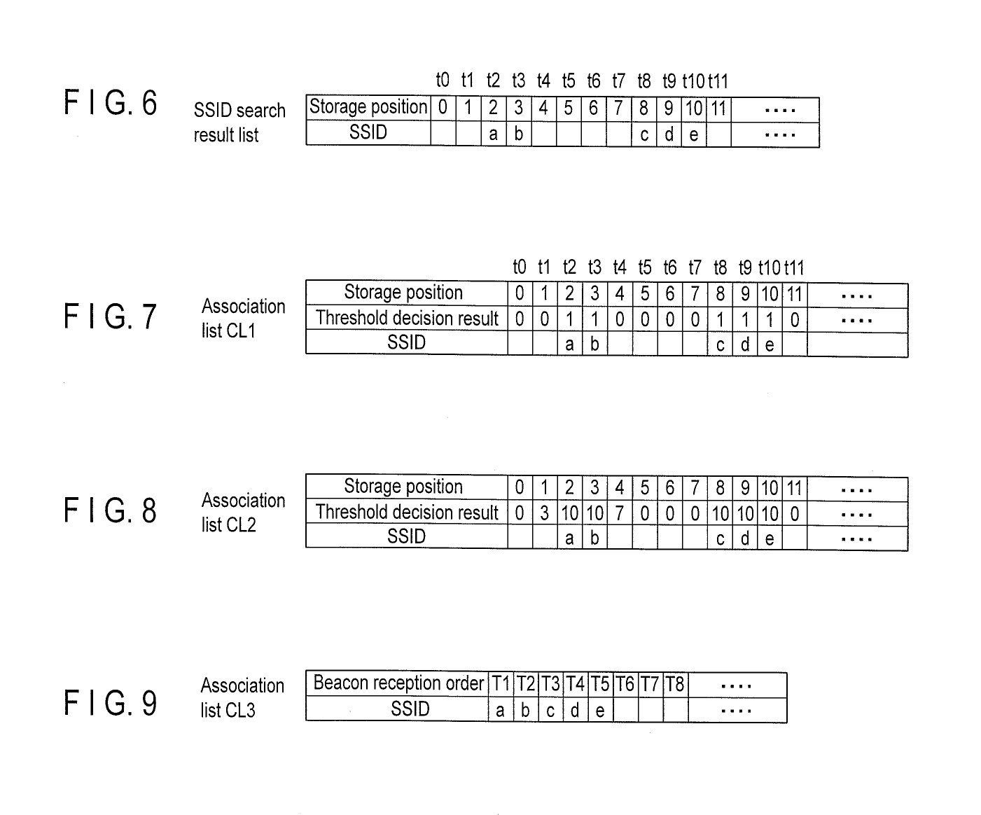

The SSID search processing is performed for an one-beacon transmission period (102.4 ms) in synchronization with a reference clock (32.768 kHz) generated from the reference frequency generating circuit 22 in the low-power-consumption wireless module 2. Thus, the SSID search result list in which the search start timing and the sampling timing are synchronized with each other is obtained for the beacon search result list L2 previously obtained in the low-power-consumption wireless module 2. The SSID search result list is stored in the register provided in the control circuit 10. The register also has 512 positions similar to the register provided in the storage section 242 of the low-power-consumption wireless module 2. FIG. 6 shows an exemplary search result list of the thus-obtained SSID, and in the figure, “a”, “b”, “c”, “d” and “e” indicate the SSID names of access points AP1 to APe, respectively.

When the SSID search result for the one-beacon transmission period (102.4 ms) is obtained, the control circuit 10 stops the operation of the wireless module 11 in step S21. The operation stop processing is performed by outputting a power-off control signal to power off the power supply switch 141 and thereby interrupting the supply of operation power from the power supply circuit 131 to the wireless module circuit 111.

(4) Processing of Associating Beacon Detection Result with SSID Detection Result

The control circuit 10 performs processing of associating the SSID search result with the beacon search result previously obtained by the low-power-consumption wireless module 2 in step S22. The following examples are considered for the association processing.

### First Example

The first example is such that the SSID search result and the beacon search result are associated with each other based on the reception time.

Since the beacon search result list L2 obtained by the low-power-consumption wireless module 2 is listed such that the sample timing is associated with the position of the register, the threshold decision result described in the beacon search result list L2 is associated with the reception timing. On the other hand, since the SSID search result list is listed such that the sample timing is associated with the position of the register, the SSID name described in the SSID search result list is associated with the reception timing. Thus, the control circuit 10 associates the beacon search result list L2 and the SSID search result list at the same position.

For example, it is assumed that the current search result list L2 is of FIG. 5(b) and the SSID search result list is of FIG. 6. In this case, the lists are associated with each other at the associated position as shown in FIG. 7. Thus, in this case, the detection data “1” of the beacons received and detected at times t1, t3, t8, t9 and t10 within the search window is associated with “a”, “b”, “c”, “d” and “e” of the SSID search result list, respectively.

According to the first example, since the beacon detection result is associated with the SSID detection result based on the reception time, the accurate association processing is enabled.

### Second Example

The second example is such that the SSID search result and the beacon search result are associated with each other based on the beacon reception level (reception power).

In other words, the beacon accumulation data obtained by the low-power-consumption wireless module 2 indicates the beacon reception level. Thus, the SSID names in the SSID search result list are sequentially associated with the accumulation values exceeding the threshold Th=8. For example, it is assumed that the beacon accumulation data is of FIG. 5(a) and the SSID search result list is of FIG. 6. In this case, the SSID names in the SSID search result list are sequentially associated with the accumulation values exceeding the threshold Th=8 as shown in FIG. 8. Thus, in this case, the detection data “10” of the beacons for which the accumulation value exceeds the threshold Th=8 within the search window is sequentially associated with “a”, “b”, “c”, “d” and “e” of the SSID search result list.

According to the second example, the beacon search result list does not need to be generated in the signal identifying section 241 of the low-power-consumption wireless module 2 and accordingly the processing load on the signal identification section 241 can be reduced and the number of registers inside the storage section 242 can be reduced.

### Third Example

The third example is such that the SSID search result and the beacon search result are associated with each other based on the order of reception.

The processing is achieved as follows, for example. In other words, the low-power-consumption wireless module 2 generates a list in which 1's in the beacon search result list L2 are arranged in the order of reception, and transmits the reception order list to the control circuit 10. The control circuit 10 generates an SSID reception order list in which the SSIDs detected during the search period are arranged in the order of reception, and associates the SSID names in the reception order list with information on the beacon reception order. For example, T1, T2, T3, . . . indicating the order of reception of the beacons are associated with the SSID names “a”, “b”, “c”, “d” and “e” in the order of reception, respectively, as shown in FIG. 9.

According to the third embodiment, the control circuit 10 may manage the beacon search result and the SSID search result only based on the order of reception. Thus, the number of register positions can be reduced and accordingly the structure of the storage section can be reduced in size.

### Fourth Example

The fourth example is such that the SSID search result and the beacon search result are associated with each other based on the reception time and the reception level.

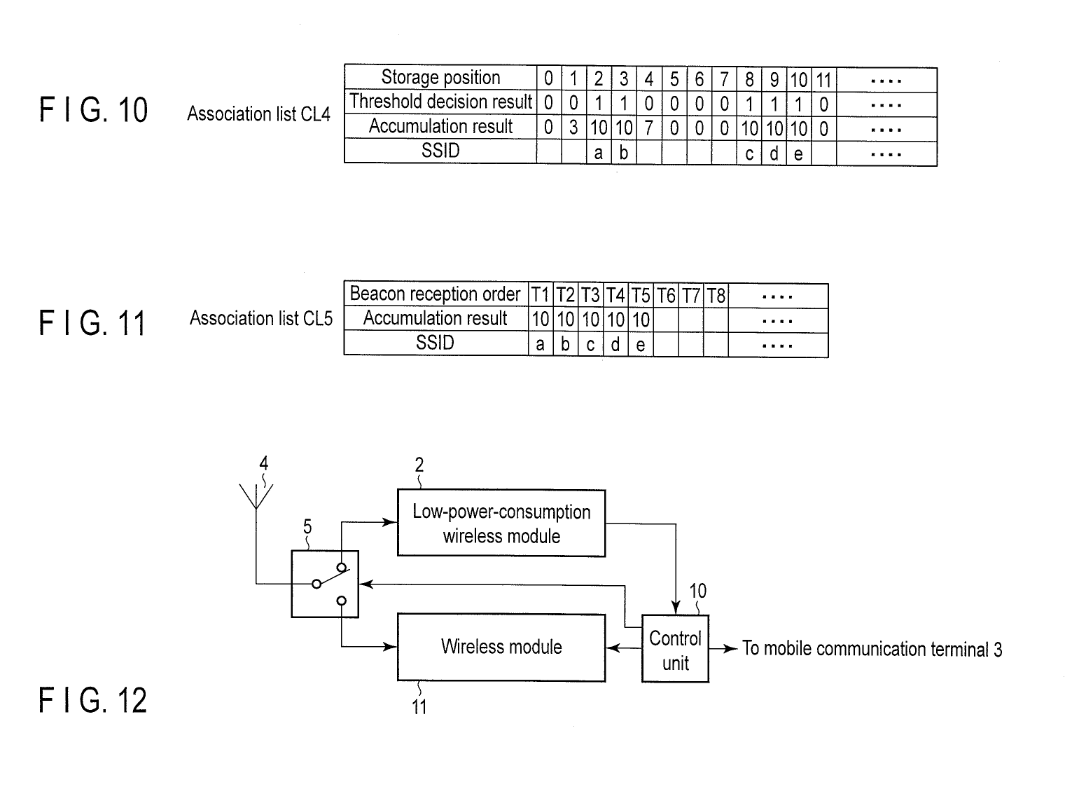

FIG. 10 shows an exemplary association result. As illustrated, the beacon search result data is associated with the accumulation result and the SSID name obtained by the SSID search based on the reception time. The association list is used so that when the information on an available access point is displayed to the mobile communication terminal main body 3 in the access point information display processing described later, the available access point's name and the reception quality of the wireless signal from the access point can be displayed.

### Fifth Example

The fifth example is such that the SSID search result and the beacon search result are associated with each other based on the order of reception and the reception level.

FIG. 11 shows an exemplary association result. As illustrated, T1, T2, T3, . . . indicating the order of reception of the beacons are associated with the beacon accumulation results and the SSID names “a”, “b”, “c”, “d” and “e”, respectively, in the order of reception. In this way, the wireless reception quality from the access points can be displayed based on the data on the association result and further the number of register positions can be reduced and accordingly the storage section can be reduced in size.

(5) Processing for Lost Beacon

When it is decided in step S19 that the beacon has disappeared from the current search result list L2, in step S26, the control circuit 10 decides the access point disappearing from the current search result list based on the list in which the past search result list and the SSID name is associated with each other. In step S22, the list in which the past search result list and the SSID name are associated with each other is corrected based on the lost beacon decision result.

When neither a new beacon nor a lost beacon is detected in step S18 and step S25, it is decided that the beacon search result list has not changed, and the processing proceeds to step S23.

(6) Access Point Information Display Processing

The control circuit 10 performs the processing of displaying the information on an available access point in step S23 as follows.

In other words, the presence of an available access point at the present is decided with reference to the association list newly created or corrected in step S22. When an available access point is present, notification data for displaying the information on the available access point is generated in step S24, and the generated notification data is transmitted to the main control unit 30 of the mobile communication terminal main body 3.

In the mobile communication terminal main body 3, the information on the available access point indicated by the notification data is displayed on the display device 31 under control of the main control unit 30. At this time, as described in the fourth example or fifth example for the association processing, when the information on the beacon reception level (accumulation result) is contained in the association list, the information on the wireless reception quality from an available access point is also displayed together with the information on the available access point.

When not being able to receive a beacon from an available access point, the mobile communication terminal main body 3 may display the information indicating that an available access point is not present on the display device 31. In other words, for example, when the disappearance of the beacon is detected in S25 and the lost beacon is from an available base station, the mobile communication terminal main body 3 may notify the fact by displaying the information indicating that the beacon from the available base station has disappeared.

As detailed above, according to the first embodiment, in the control circuit 10, the beacon search result detected in the low-power-consumption wireless module 2 and the SSID search result detected by the wireless module 11 are associated with each other according to at least one of the reception time, the reception level and the order of reception. Thus, the information on the available access point at the present can be displayed on the display device 31 of the mobile communication terminal main body 3 with reference to the association list without activating the wireless module 11 other than when a new beacon is detected.

In other words, the information on the available access points can be held only by intermittently operating the low-power-consumption wireless module 2 and operating the wireless module 11 with high power consumption only as needed, and thereby there can be provided the mobile communication terminal with less power consumption capable of perpetually presenting the information necessary for utilizing an access point to the user.

The down converter 212 provided in the low-power-consumption wireless module circuit 21 typically has a long time constant, and once being saturated, takes a long time to recover to the initial state. Therefore, when the beacon search is tried to make in the low-power-consumption wireless module 2 immediately after the wireless transmission, the search operation can be adversely affected. However, in the first embodiment, the antenna 25 is separated from the low-power-consumption wireless module circuit 21 in the low-power-consumption wireless module 2 during the transmission period of the wireless modules 11 to 1n. Thus, the failure that the down converter 212 is saturated due to the wireless signals transmitted from the wireless modules 11 to 1n can be prevented, thereby accurately making the beacon search even immediately after the wireless transmitting operation. The low-noise amplifier of the RF signal receiving section 211 may not be required depending on desired reception sensitivity and the down converter 212 may directly receive the signal.

### Second Embodiment

FIG. 12 is a diagram showing a structure of a wireless unit in a mobile communication terminal according to a second embodiment. The wireless unit according to the present embodiment comprises an antenna 4 shared between the wireless module 11 and the low-power-consumption wireless module 2, and switches an antenna changeover switch 5 under control of the control circuit 10 to connect either one of the wireless module 11 and the low-power-consumption wireless module 2 to the antenna 4.

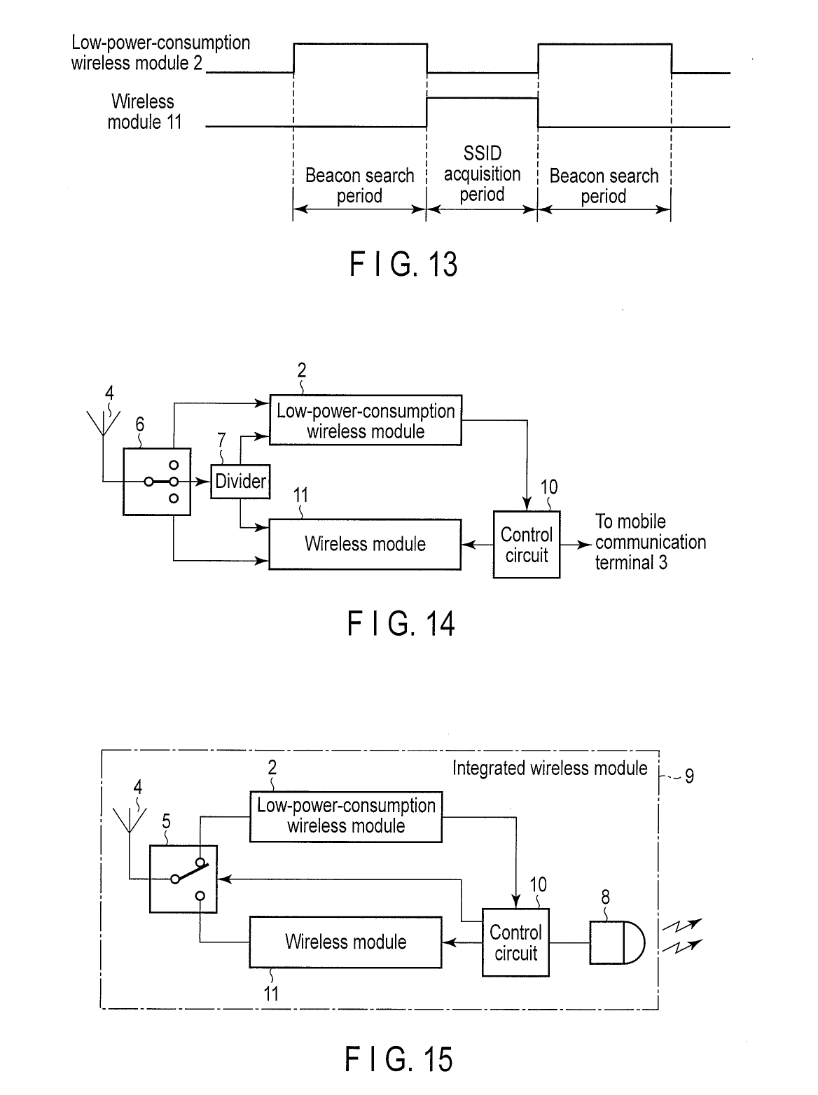

FIG. 13 shows exemplary operation periods of the low-power-consumption wireless module 2 and the wireless module 11 in the mobile communication terminal according to the second embodiment. In the figure, during the period in which the beacon search is made by the low-power-consumption wireless module 2, the antenna changeover switch 5 is switched to the low-power-consumption wireless module 2 so that the beacon search processing is performed. When a new beacon is detected by the beacon search processing, the antenna changeover switch 5 is switched to the wireless module 11 so that the SSID search processing is performed by the wireless module 11. The above operations are controlled by the control circuit 10.

A series of processings of associating the beacon search result obtained during the beacon search period with the SSID search result obtained during the SSID search period are the same as the processings according to the first embodiment described with reference to FIG. 3.

In this way, according to the second embodiment, the beacon search result and the SSID search result can be associated with each other even in the wireless module in which the antenna 4 is shared between the wireless module 11 and the low-power-consumption wireless module 2.

### Third Embodiment

FIG. 14 is a diagram showing a structure of a wireless unit in a mobile communication terminal according to a third embodiment. The wireless unit according to the present embodiment comprises the antenna 4 shared between the wireless module 11 and the low-power-consumption wireless module 2, and switches an antenna changeover switch 6 under control of the control circuit 10 to connect either one of the wireless module 11 and the low-power-consumption wireless module 2 to the antenna 4. Additionally, the wireless unit comprises a divider 7, and connects the antenna 4 to the divider 7 by the antenna changeover switch 6 to divide the wireless signal received at the antenna 4 into both the wireless module 11 and the low-power-consumption wireless module 2 by the divider 7. The switch control of the changeover switch 6 is performed by the control circuit 10.

With the structure, when the changeover switch 6 is switched to the divider 7, the wireless signal received at the antenna 4 is branched by the divider 7 to be input to both the wireless module 11 and the low-power-consumption wireless module 2. Therefore, when a new beacon is detected through the beacon search by the low-power-consumption wireless module 2, the changeover switch 6 is switched to the divider 7 under control of the control circuit 10 so that the SSID search processing by the wireless module 11 and the beacon research processing by the low-power-consumption wireless module 2 can be made in parallel during the same period.

According to the third embodiment, the beacon search result and the SSID search result obtained during the same period can be associated with each other.

### Fourth Embodiment

There has been described in the first embodiment the case in which the wireless module group 1 and the low-power-consumption wireless module 2 are provided in the mobile communication terminal by way of example. In contrast, in the fourth embodiment, the wireless unit comprising the wireless module 11, the low-power-consumption wireless module 2 and the control circuit 10 is configured as an independent integrated wireless module.

FIG. 15 is a block diagram showing a structure of the integrated wireless module 9. As illustrated, the integrated wireless module 9 comprises the wireless module 11, the low-power-consumption wireless module 2, the control circuit 10, the antenna 4, the antenna changeover switch 5 and a light-emitting device 8. The control circuit 10 decides the presence of an available access point based on the data in which the beacon search result and the SSID search result are associated with each other in step S23 as shown in FIG. 3. When an available access point is present, a display signal for presenting the fact to the user is generated in step S24 and is output to the light-emitting device 8. The light-emitting device 8 comprises an LED, for example, and is lit when receiving the display signal.

Thus, according to the fourth embodiment, the information on the access point can be generated and presented by the integrated wireless module 9 without operating the mobile communication terminal. Thus, the power consumption of the mobile communication terminal can be further reduced.

The light-emitting device 8 may employ a device capable of varying an emission color, and as described in the fourth and fifth examples of the first embodiment, the emission color of the light-emitting device 8 may be changed depending on the reception level of the beacon from the available access point. In this way, the user can confirm not only the presence of an available access point but also the wireless reception quality of the access point. The number of light-emitting devices 8 is not limited to one and a plurality of light-emitting devices 8 may be provided to display the wireless reception quality of the access point and the number of available access points.

A typical beacon period has been described above, and a different notification information period may be similarly applied depending on a wireless system to be detected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless unit configured to wirelessly communicate with a base station, the wireless unit comprising:
a first wireless module configured to receive an identification signal transmitted from the base station, and to detect whether the base station is available, the identification signal comprising information associated with the base station;
a second wireless module configured to operate using less power than the first wireless module and to detect whether the identification signal arrives within a time period; and
a notification module configured to notify an external module when the identification signal arrives within the time period.

2. The wireless unit of claim 1, wherein the first wireless module is further configured to decode the received identification signal and to determine based on the decoded signal whether the base station is available, and
the second wireless module further configured to determine, by detecting an envelope of the identification signal, whether the identification signal arrives within the time period.

3. The wireless unit of claim 2, further comprising:
a storage module configured to store at least one of an electric power value of a first signal, a receive time of the first signal, and a receive order of the first signal, the first signal comprising the identification signal from the available base station, and wherein
the notification module is further configured to notify the external module when the first signal arrives at the second wireless module.

4. The wireless unit of claim 3, wherein
the second wireless module is further configured to detect at least one of the electric power, the receive time, and the receive order, and
the storage module is further configured to store at least one of the electric power value, the receive time and the receive order, wherein the electric power value, the receive time and the receive order are detected by the second wireless module during the same period when the first wireless module receives the first signal.

5. A wireless unit configured to wirelessly communicate with a base station, the wireless unit comprising:
a first wireless module configured to receive identification information associated with the base station, the identification information transmitted by the base station;
a second wireless module configured to operate using less power than the first wireless module and to receive a beacon signal transmitted by the base station; and
a control module connected to the first and second wireless modules,
wherein the second wireless module comprises:
a determination module configured to detect reception power of the beacon signal and to determine whether the detected reception power of the beacon signal satisfies a threshold; and
an output interface configured to provide to the control module output identification detection information comprising information associated with the detected beacon signal in response to the detected reception power satisfying the threshold, and
wherein the control module comprises:
a first controller configured to receive the identification detection information from the second wireless module;
a second controller configured to operate the first wireless module for a period of time in response to the received identification detection information comprising information associated with a new beacon signal;
a third controller configured to receive identification information received by the first wireless module during the operation period of the first wireless module; and
a fourth controller configured to associate the received identification information with information associated with the beacon signal, the information included in the received identification detection information, the fourth controller further configured to store information on the association.

6. The wireless unit of claim 5,
wherein the output interface of the second wireless module is further configured to provide to the control modules identification detection information comprising information on at least one of a reception power value, a reception time, and an order of reception of the detected beacon signal, and
the fourth controller of the control module is further configured to associate the received identification information with the information of the detected beacon signal based on the information of at least one of the reception power value, the reception time and the order of reception of the detected beacon signal.

7. The wireless unit of claim 5, wherein the control module further comprises:
a fifth controller configured to determine whether the base station is available based on the stored information of the association; and
a display configured to display information associated with a determination result of the availability of the base station.

8. The wireless unit of claim 5, wherein the control module further comprises a sixth controller configured to decide, when the control module is connected with a mobile communication terminal, whether the base station is available based on the stored information on the association and to provide notification information on the determination result to the mobile communication terminal.

9. The wireless unit of claim 5, further comprising:
an antenna; and
a switching circuit configured to connect one of the first and second wireless modules to the antenna,
wherein the control module further comprises a seventh controller configured to connect the first wireless module to the antenna during an operation period of the first wireless module and to connect the second wireless module to the antenna during other periods.

10. The wireless unit of claim 5, further comprising:
an antenna; and
a dividing circuit configured to divide a wireless signal received by the antenna and to provide the wireless signal to the first and second wireless modules,
wherein the fourth controller in the control module associates identification information received by the first wireless module during the operation period of the first wireless module with information of the beacon signal detected by the second wireless module during the operation period of the first wireless module.

11. The wireless unit of claim 5, wherein the control module further comprises:
an eighth controller configured to transmit a wireless signal comprising a transmission request from the first wireless module to the base station; and
a ninth controller configured to associate identification information transmitted from the base station in response to the transmission request and received by the first wireless module with information of the beacon signal transmitted from the base station in response to the transmission request and detected by the second wireless module.

12. The wireless unit of claim 5, further comprising a switch provided between the second wireless module and an antenna,
wherein the control module further comprises a tenth controller configured to control the switch for separating the second wireless module from the antenna while the first wireless module is transmitting a wireless signal.

13. The wireless unit of claim 5, wherein reception sensitivity of the beacon signal by the second wireless module is lower than reception sensitivity of identification information by the first wireless module.

14. A mobile communication terminal configured to wirelessly communicate with a base station, the mobile communication terminal comprising:
a first wireless module configured to receive from the base station identification information associated with the base station;
a second wireless module configured to operate with less power than the first wireless module and to receive a beacon signal transmitted by the base station;
a control module connected to the first and second wireless modules; and
a display module connected to the control module,
wherein the second wireless module comprises:
a determination module configured to detect reception power of the beacon signal and to determine whether the detected reception power of the beacon signal satisfies a threshold; and
an output interface configured to provide to the control module output identification detection information comprising information associated with the detected beacon signal in response to the detected reception power satisfying the threshold, and
wherein the control module comprises:
a first controller configured to receive the identification detection information from the second wireless module;
a second controller configured to operate the first wireless module for a period of time in response to the received identification detection information comprising information associated with a new beacon signal;
a third controller configured to receive identification information received by the first wireless module during the operation period of the first wireless module;
a fourth controller configured to associate the received identification information with information associated with the beacon signal, the information included in the received identification detection information, the fourth controller further configured to store information on the association;
a fifth controller configured to determine whether the base station is available based on the stored information of the association; and
a sixth controller configured to display on the display module a determination result associated with the availability of the base station.

15. The mobile communication terminal of claim 14, wherein
the output interface of the second wireless module is further configured to provide to the control module identification detection information comprising information on at least one of a reception power value, a reception time, and an order of reception of the beacon signal, and
the fourth controller of the control module is further configured to associate the received identification information with the information of the detected beacon signal based on the information of at least one of the reception power value, the reception time, and the order of reception of the detected beacon signal.

16. The mobile communication terminal of claim 14, further comprising:
an antenna; and
a switching circuit configured to connect one of the first and second wireless modules to the antenna,
wherein the control module further comprises a seventh controller configured to connect the first wireless module to the antenna during an operation period of the first wireless module and to connect the second wireless module to the antenna during other periods.

17. The mobile communication terminal of claim 14, further comprising:
an antenna; and
a dividing circuit configured to divide a wireless signal received by the antenna and to provide the wireless signal to the first and second wireless modules,
wherein the fourth controller in the control module associates identification information received by the first wireless module during the operation period of the first wireless module with information of the beacon signal detected by the second wireless module during the operation period of the first wireless module.

18. The mobile communication terminal of claim 14, wherein the control module further comprises:
an eighth controller configured to transmit a wireless signal comprising a transmission request from the first wireless module to the base station; and
a ninth controller configured to associate identification information transmitted from the base station in response to the transmission request and received by the first wireless module with information of the beacon signal transmitted from the base station in response to the transmission request and detected by the second wireless module.

19. The mobile communication terminal of claim 14, further comprising a switch provided between the second wireless module and an antenna,
wherein the control module further comprises a tenth controller configured to control the switch for separating the second wireless module from the antenna while the first wireless module is transmitting a wireless signal.

20. The mobile communication terminal of claim 14, wherein reception sensitivity of the beacon signal by the second wireless module is lower than reception sensitivity of identification information by the first wireless module.
